(19) United States
(12) Patent Application Publication
(10) Pub. No.: US 2009/0102236 A1
(43) Pub. Date: Apr. 23, 2009

(54) Front-End Vehicle Structure for a Commercial Vehicle

(75) Inventors: Mario List, Remseck (DE); Wolfgang Pedrotti, Ostfildern (DE)

Correspondence Address: CROWELL & MORING LLP;INTELLECTUAL PROPERTY GROUP, P.O. BOX 14300, WASHINGTON, DC, 20044-4300, US

(73) Assignee: Daimier AG, Stugart (DE)

(21) Appl. No.: 11/996,401

(22) PCT Filed: Jul. 12, 2006
(86) PCT No.: PCT/EP2006/006799

§ 371 Date: Jul. 25, 2008

(30) Foreign Application Priority Data
Jul. 23, 2005 (DE) 102005034469.0

(51) Int. Cl. B62D 21/15

(52) U.S. Cl. 296/187.09

(57) ABSTRACT

A front-end vehicle structure for a commercial vehicle has a forward crash zone and a rear crash zone relative to the longitudinal direction of the vehicle. The forward crash zone and the rear crash zone are interconnected via an intermediate structure which is mounted therebetween and extends substantially perpendicular to the longitudinal direction of the vehicle such that a force that is applied to the forward crash zone can be transmitted to the rear crash zone via the intermediate structure.

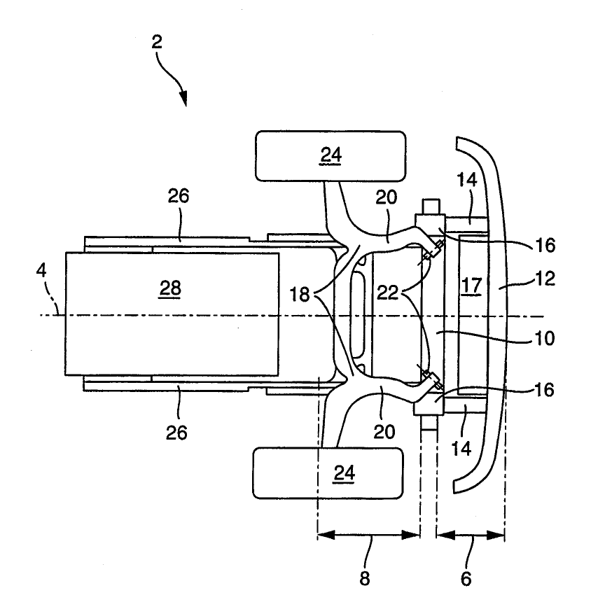

### BACKGROUND AND SUMMARY OF THE INVENTION

This invention relates to a front-end vehicle structure for a commercial vehicle including a front crash zone and a rear crash zone in the longitudinal direction of the vehicle.

A vehicle front-end structure of this type is known, for example, from German document DE 102 54 693 A1. The front crash zone comprises a bumper and two crash-box parts. The rear crash zone comprises two side members which form part of the frame structure of a commercial vehicle. The crash zones are interconnected by a plurality of connecting supports extending substantially in the longitudinal direction of the vehicle, with one connecting support being provided in each case for connecting a crash-box part to a side member.

An underride protection for trucks and buses is known from German document DE 101 30 637 A1. The front crash zone has a bumper and two overhanging supports. The overhanging supports are connected to the vehicle frame via corner plates. The vehicle frame has side members and crosswise reinforcement.

A driver's cab for a commercial vehicle, the rear crash zone of which is configured as a support structure with two hollow-profile carriers, is known from German document DE 103 36 200 A1. The front crash zone is formed by a crash element which extends between the two hollow-profile carriers and partially beyond the latter.

Known from German document DE 38 27 923 A1 is a frame for motor vehicles in which the front crash zone is formed by a cross-member. The rear crash zone is formed by two side members of the vehicle frame. Each of these side members is connected to the cross-member of the front crash zone via support elements extending forwards in a V-formation.

With the known front-end vehicle structures, impact forces arising in the event of an accident can be applied to the front crash zone. In the case of high impact forces, both the front crash zone and the rear crash zone are deformed. In this case the deformable components of one crash zone are each connected to the deformable components of the other crash zone.

Starting from the above, it is the object of the present invention to create a front-end vehicle structure for a commercial vehicle which allows the front and rear crash zones to be designed very largely independently, that is, according to separate criteria.

This object is achieved according to the invention by interconnecting the front and rear crash zones, via a spatially interposed intermediate structure extending substantially transversely to the longitudinal direction of the vehicle, such that a force applied to the front crash zone can be transmitted to the rear crash zone via the intermediate structure.

In the context of this invention “crash zone” is understood to mean a three-dimensional structure formed from at least one component which is at least partially deformable in the longitudinal direction of the vehicle, in order to dissipate energy by deformation. Because of the intermediate structure arranged between the crash zones, the front crash zone can be designed very largely independently of the rear crash zone. Whereas, in the structures known from the prior art, the crash structures of the front and rear crash zones adjoin one another directly, the front and rear crash structures according to the invention are decoupled from one another by an intermediate structure extending substantially transversely to the longitudinal direction of the vehicle.

The front-end vehicle structure according to the invention enables the front crash zone to be designed according to different conditions to the rear crash zone. Thus, the front crash zone may be comparatively easily deformable, in order, in the event of an accident with a weaker accident opponent, for example a passenger car or a pedestrian, to allow this accident opponent greater protection than with a stiffer front crash zone. For absorbing high impact energies, for example in a collision with another commercial vehicle, the rear crash zone, which may be designed substantially stiffer than the front crash zone, may be deformed.

The elements of the front crash zone and of the rear crash zone which are deformable in the longitudinal direction are each connected to the intermediate structure. A force applied to the front crash zone is therefore not transmitted to the rear crash zone directly, but via the interposition of the intermediate structure. In this case the crash elements of the front and rear crash zones may be offset to one another in the transverse direction of the vehicle. It is therefore no longer necessary for the crash elements to be aligned with one another in the longitudinal direction of the vehicle, as known from the prior art.

According to an advantageous embodiment of the invention, the intermediate structure is configured in one piece. Such an intermediate buffer may be formed, for example, by a cross-member. The cross-member serves to decouple the front and rear crash zones from one another. Furthermore, stiffening of the vehicle structure can be achieved with the cross-member.

According to an advantageous development of the invention, the front crash zone has crash elements in the form of crash boxes. Such crash boxes are usually comparatively easily deformable, in comparison to the vehicle frame structure, in order to be able to dissipate energy through deformation. In an accident, over-stiff design of the crash boxes would lead to higher acceleration values for both accident opponents.

The front crash zone can serve for mounting easily deformable units, in particular a radiator. Energy dissipation can therefore be effected not only by specially configured crash elements, but also by further units arranged in the front region of a commercial vehicle.

If the front crash zone is connected detachably to the intermediate structure, the commercial vehicle can be repaired, after an accident with small impact forces, by removal of the front crash zone from the intermediate structure and replacement with a new front crash zone.

If the rear crash zone has crash structures formed by chassis elements of the commercial vehicle, forces applied to the front crash zone can be applied via the intermediate structure to a crash zone which is more easily deformable in comparison to the frame of a commercial vehicle. In this way peak accelerations occurring in an accident can be minimized.

The crash elements of the front crash zone and/or the crash structures of the rear crash zone may be arranged parallel to one another in the longitudinal direction of the vehicle. The impact forces arising in a frontal collision can thereby be dissipated in an optimum manner.

It is further proposed that the deformation resistance of the front crash zone is lower than the deformation resistance of the rear crash zone. In this way partner protection for the accident opponent can be improved.

If the deformation resistance of the intermediate structure is higher than the deformation resistance of the front crash zone, it is ensured that the deformation of the rear crash zone begins only when the front crash zone has been completely deformed. A repair-friendly front-end vehicle structure can thereby be formed.

The front crash zone may be arranged in a relatively low region in relation to the height of the vehicle, corresponding to the impact height of an accident opponent in the form of a passenger car. Partner protection of comparatively weaker accident opponents can therefore be improved.

Additionally or optionally, the front crash zone may be arranged in a relatively high region in relation to the height of the vehicle, corresponding to the impact height of an accident opponent in the form of a commercial vehicle. Impact energies can thereby be dissipated in steps in a collision with another commercial vehicle or with a bus.

Further advantageous configurations and details of the invention are apparent from the following description, in which the invention is described and explained in more detail with reference to the exemplary embodiment represented in the drawing.

### BRIEF DESCRIPTION OF THE DRAWINGS

The single FIGURE shows the substructure of a front-end vehicle structure for a commercial vehicle in a top view.

### DETAILED DESCRIPTION OF THE INVENTION

The front-end vehicle structure denoted as a whole by reference 2 is configured substantially symmetrically with respect to the longitudinal direction of the vehicle 4.

The front-end vehicle structure 2 comprises a front crash zone 6 and a rear crash zone 8 in the longitudinal direction of the vehicle 4. Between the crash zones 6 and 8 there is arranged an intermediate structure 10 which is in the form of a cross-member and extends substantially transversely to the longitudinal direction of the vehicle 4.

The front crash zone 6 has a bumper 12 arranged substantially transversely to the longitudinal direction of the vehicle 4, the rear of which bumper 12, in the forward direction of travel, is adjoined on the left-hand and right-hand sides by a crash box 14 in each case. Each crash box 14 is connected to the intermediate structure 10 via a connecting element 16.

In addition, an easily deformable radiator 17 is arranged in the front crash zone 6.

The rear crash zone 8 is formed by chassis elements 18, which comprise two arms 20 oriented forwardly in the longitudinal direction of the vehicle 4 towards the front crash zone 6. These arms 20 are each connected via respective connecting elements 22 to the intermediate structure 10.

The chassis elements 18 also serve for mounting the front wheels 24 of the commercial vehicle, which is not further illustrated.

The chassis elements 18 are connected by their rear ends to side members 26 of a vehicle frame. The engine 28 of the commercial vehicle is accommodated between the side members 26.

In the event of an accident with small impact forces, a force is applied to the bumper 12 and to the adjoining crash boxes 14. The latter are deformed while bearing against the intermediate structure 10 via the connecting elements 16.

In the event of an accident with relatively large impact forces, the deformation of the front crash zone 6 is followed by the deformation of the rear crash zone 8. In this case the arms 20 are progressively buckled. As this happens the rear crash zone 8 bears against the side members 26 of the vehicle frame. In the event of very large impact forces the deformation of the rear crash zone 8 is followed by a deformation of the side members 26 and of the engine 28.

1-13. (canceled)

14. A front-end vehicle structure for a commercial vehicle, comprising:
a front crash zone,
a rear crash zone disposed in the longitudinal direction of the vehicle relative to the front crash zone, and
a spatially interposed intermediate structure extending substantially transversely to the longitudinal direction of the vehicle and interconnecting the front crash zone and the rear crash zone such that a force applied to the front crash zone is transmittable to the rear crash zone via the intermediate structure.

15. The front-end vehicle structure as claimed in claim 14, wherein the intermediate structure is configured in one piece.

16. The front-end vehicle structure as claimed in claim 14, wherein the intermediate structure is formed by a cross-member.

17. The front-end vehicle structure as claimed in claim 14, wherein the front crash zone comprises crash elements in the form of crash boxes.

18. The front-end vehicle structure as claimed in claim 14, wherein the front crash zone serves for mounting at least one easily deformable unit.

19. The front-end vehicle structure as claimed in claim 18, wherein the easily deformable unit is a radiator.

20. The front-end vehicle structure as claimed in claim 14, wherein the front crash zone is connected detachably to the intermediate structure.

21. The front-end vehicle structure as claimed in claim 14, wherein the rear crash zone comprises crash structures which are formed by chassis elements of the commercial vehicle.

22. The front-end vehicle structure as claimed in claim 14, wherein the rear crash zone is connected to a vehicle frame.

23. The front-end vehicle structure as claimed in claim 14, wherein crash elements of the front crash zone, crash structures of the rear crash zone, or crash elements of the front crash zone and crash structures of the rear crash zone are arranged parallel to one another in the longitudinal direction of the vehicle.

24. The front-end vehicle structure as claimed in claim 14, wherein a deformation resistance of the front crash zone is lower than a deformation resistance of the rear crash zone.

25. The front-end vehicle structure as claimed in claim 14, wherein a deformation resistance of the intermediate structure is higher than a deformation resistance of the front crash zone.

26. The front-end vehicle structure as claimed in claim 14, wherein the front crash zone is arranged in a relatively low region in relation to the height of the vehicle, corresponding to an impact height of an accident opponent.

27. The front-end vehicle structure as claimed in claim 26, wherein the accident opponent is a passenger car.

28. The front-end vehicle structure as claimed in claim 14, wherein the front crash zone is arranged in a relatively high region in relation to the height of the vehicle, corresponding to the impact height of an accident opponent.

29. The front-end vehicle structure as claimed in claim 28, wherein the accident opponent is a commercial vehicle.
